(19) United States
(12) Patent Application Publication
(10) Pub. No.: US 2009/0007203 A1
(43) Pub. Date: Jan. 1, 2009

(54) Enhanced Interactive Television Return Path

(76) Inventors: Jonathan Peter Vincent Drazin, Berkshire (GB); David Jonathan Caswell, South Oxon (GB); Jason Robert Malaure, Sydney (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/158,767

(22) PCT Filed: Dec. 18, 2006
(86) PCT No.: PCT/GB2006/004717

§ 371 Date: Sep. 10, 2008

(30) Foreign Application Priority Data
Dec. 21, 2005 (GB) 0525995.7

(51) Int. Cl. H04N 7/173

(52) U.S. Cl. 725/106

(57) ABSTRACT

A method for providing services to a television system, the method comprising receiving a user message via a telephone line, the message including a translated version of user information (436); using the message received to identify an address for the television system associated with the user and broadcasting a return message for receipt by the television system, the return message including the television system address.

This invention relates to television receiving apparatus that contain a user interactive function.

### BACKGROUND OF THE INVENTION

Many television apparatus do not have hardware return path functionality. This can limit access to interactive services, particularly when the user's hardware is not pre-registered with a service provider or when payment for such services is required. To overcome these problems, text messages have been employed to allow a return path. However, this sometimes requires a user to enter long codes or numbers. This can be cumbersome and prone to error. This is a particular problem when the service operator has no knowledge of the address for a particular apparatus, because the address then has to be included in the text message. Since the address of an apparatus is typically eight decimal digits long, it is inconvenient for a user to include this in a mobile text message each time an order is placed.

### SUMMARY OF THE INVENTION

According to one aspect of the present invention, there is provided a method for providing interactive television services, the method comprising receiving a user message via a telephone line, the message including a translated version of user information; using the message to identify an address for the television system associated with the user and broadcasting a return message for receipt by the television system, the return message including the television system address.

Preferably, the user message is a text message and the translated information comprises one or more short character strings, preferably language words. In this way, the need for a user to enter long complex sequences of characters is avoided, whilst at the same time giving service providers enough information to allow user requests to be reliably interpreted and acted on.

The user message may include a television service request. The user message may include a translated version of the television system address. The television address may be a transient address. The transient address may be a one-time use address. The address may be generated by the television system using a pseudo-random generator.

The user message may include a service request and the return message may include an entitlement message, which entitles a user to access that service.

The method may further involve storing user telephone numbers and identifying a user from the telephone number from which the user message is received. Stored in association with the user's telephone number may be a television system address for the user's television system. Stored in association with the user's telephone number may be addresses for a plurality of television systems, each television address being allocated a coupling code.

According to another aspect of the present invention, there is provided a system for providing television services, the system comprising means for receiving a user message via a telephone line, the message including a translated version of user information; means for using the message received to identify an address for the television system associated with the user and means for broadcasting a return message for receipt by the television system, the return message including the television system address.

According to yet another aspect of the present invention, there is provided a method for accessing television services, the method comprising sending to a service provider a user message via a telephone line, the message including a translated version of user information and enabling identification of an address for a television system associated with the user and receiving a return message at the television system via a television broadcast channel.

The method may further involve receiving one or more user selections and providing a translated version of user information in response to the user selections for transmission to the service provider.

The method may further involve identifying at the television system one of a plurality of registered users and including in the user information a code associated with that user.

### BRIEF DESCRIPTION OF THE DRAWINGS

Various aspects of the invention will now be described by way of example only and with reference to the accompanying drawings, of which:

FIG. 1 is a block diagram of the overall system comprising a service operator, a broadcaster, a telephone communications network and a television receiving apparatus;

FIG. 2 is a block diagram of a television receiving apparatus that is configured to receive data from the operator via a broadcast television network;

FIG. 3 is a top view of the remote control handset used in the system of FIG. 2;

FIG. 4 is a block diagram of the functions within a digital television receiving apparatus;

FIG. 5 shows how memory is allocated by function in the television receiving apparatus of FIG. 4;

FIG. 6 shows how non-volatile memory is allocated by function in the television receiving apparatus of FIG. 4;

FIG. 7 shows the screen of the television platform when it is displaying a full screen television programme;

FIG. 8 shows the screen of the television apparatus when it is displaying a service guide whereby products and services may be selected or ordered by a user;

FIG. 9 shows a flow diagram showing the order process when the mobile telephone number is used to identify the apparatus;

FIG. 10 is a diagram that shows communications of information between the user, the apparatus and the operator that form the order process in chronological order down the page, where a mobile telephone number is used to identify the apparatus to the operator;

FIG. 11 shows the screen of the television apparatus when it is displaying a product or subscription menu whereby users may order products or services;

FIG. 12 shows the screen of the television apparatus when it is displaying a prompt for a user to identify which mobile telephone a user wants to use to order a products or service;

FIG. 13 shows the screen of the television apparatus when it is displaying a request for a user to register the number of a new mobile telephone to be used to order a product or service;

FIG. 14 shows the screen of the television apparatus when it is displaying a request for a user to text a message containing an order code to a service operator;

FIG. 15 shows a flow diagram showing the order process where a transient address is communicated to the operator for addressing of the entitlement to the apparatus;

FIG. 16 is a diagram that shows communications of information between the user, the apparatus and the operator that form the order process in chronological order down the page, where a transient address is communicated to the operator for addressing of the entitlement to the apparatus, and

FIG. 17 shows the screen of the television apparatus when it is displaying a request for a user to photograph an image containing an order code for decoding within the mobile telephone and transmission to a service operator.

### SPECIFIC DESCRIPTION OF THE DRAWINGS

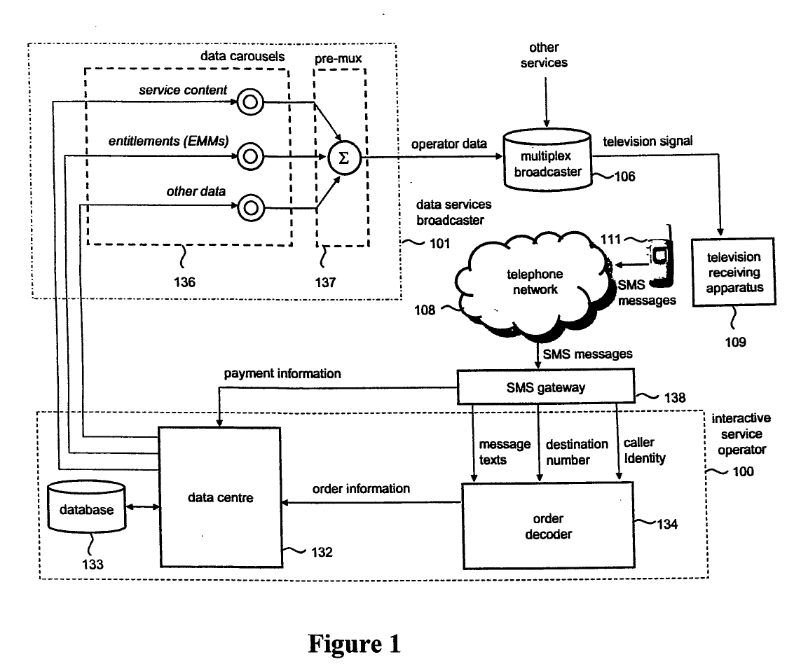

FIG. 1 shows a television receiving apparatus 109 that is operable to receive service and content data from an interactive service operator 100 via a broadcaster 101 and a multiplex broadcaster 106. The apparatus 109 displays instructions for its user to compose text messages such as offered by the mobile telephone Short Message Service (SMS) on a mobile telephone handset 111 for transmission across a telephone network 108 to the operator 100.

The operator 100 may offer a range of interactive services and products including an interactive programme guide (IPG) service, an electronic games service, a news and weather service, a betting service and an interactive chat service. The operator has an order decoder 134 for receiving and decoding incoming SMS text messages and a data centre 132 for aggregating service content and other service related information and transmitting that information to a services broadcaster 101. Additionally, the operator transmits to the data services broadcaster 101 a stream of entitlement management messages (EMMs) that are for forwarding to individual apparatus 109, or to sets of individual apparatus, to allow or disallow user access on to individual services or groups of services. Each EMM is a short message that entitles apparatus with one or a range or list of addresses to display a specified service or content product in a specified maimer (e.g. single play, for 24 hours or until 31 Dec. 2005).

A number of destination telephone numbers are allocated to the interactive service operator 100. SMS text messages sent to these numbers are received by an SMS gateway 138 and forwarded onto the operator 100 in real time. For each SMS text message received the SMS gateway forwards to the operator's order decoder 134 the message text, the identities of the destination SMS telephone number (“line identity”) and the telephone numbers of the sending mobile telephone 111 using caller line identification (CLI) (“caller identity”). The SMS text messages may be received by the SMS gateway 138 on a premium rate mobile telephone number, where the user's mobile telephone operator collects a payment from the user and remits an aggregated payment to the interactive service operator 100. In such case, the SMS gateway sends payment information concerning each SMS text message to the operator's data centre 132.

The order decoder 134 parses the message texts, line and caller identities according to a process to be described later in order to extract order information, which is forwarded in real time to the data centre 132. Preferably the order decoder is a fault redundant personal computer that is adapted to communicate with the SMS gateway and the data centre. A user pre-registers or “couples” a mobile telephone to an individual apparatus. A single mobile telephone may be coupled with up to 15 different apparatus. The identities for each coupling of a mobile phone and an apparatus's apparatus address (see later) are stored as a data table within the order decoder (134), as shown in the following example table:

| Mobile | manufacturer | | |
|---|---|---|---|
| telephone | identifier | | coupling |
| number (T) | (M) | apparatus address (A) | (C) |
| 07767 | 0x17 | 0x3F7A030E | 0 |
| 623293 | | | |
| 0727 | 0x24 | 0x0CE7AADE | 0 |
| 828142 | | | |
| 0727 | 0x3A | 0x0013FFA1 | 1 |
| 828142 | | | |
| 0777 | 0x3A | 0x1A430361 | 0 |
| 234520 | | | |
| 0777 | 0x1D | 0x0FE00829 | 1 |
| 234520 | | | |
| 0777 | 0x11 | 0x0043EF1A | 2 |
| 234520 | | | |
| . . . | . . . | . . . | . . . |

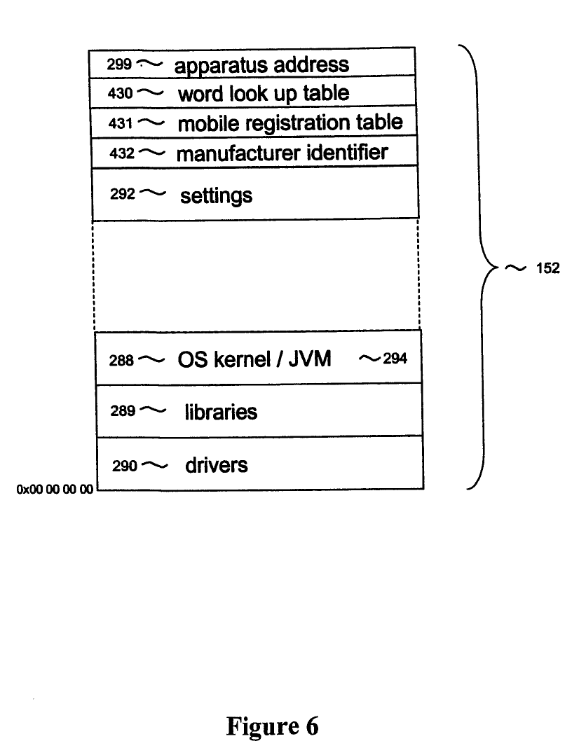

The coupling field, C, denotes a counter for each association between an apparatus address, A, for a given mobile telephone number, T. In the above example, one mobile telephone (07767 623293) is coupled once, while one (0727 828142) is coupled with two apparatus and a third (0777 234520) is couple with 3 apparatus. The order decoder also contains a copy of the word look up table (see later 430 of FIG. 6).

The data services broadcaster applies the incoming data streams from the operator 100 to a data carousel 136 and pre-multiplexes these together for transmission to a multiplex broadcaster 106 for combination with other services such as television and radio channels and interactive data services. Data is preferably transmitted as one or more modules using the so-called DSM-CC (Digital Storage Media Command and Control) object carousel 136. The DSM-CC carousel is a data stream transmitted by the broadcasting station alongside television audio-video service data, where each module comprises executable code and/or data components of one or more data packets that may be downloaded by television receiving apparatus.

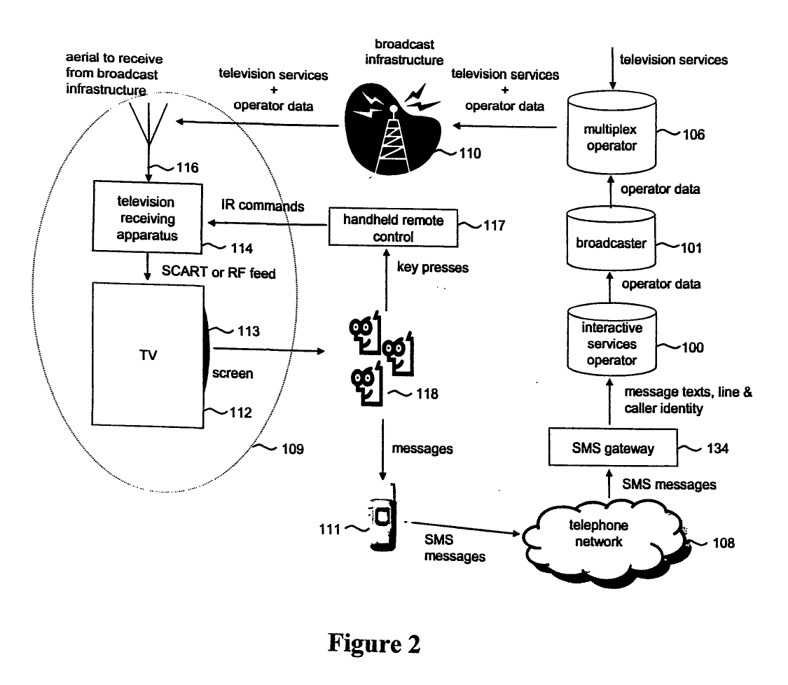

FIG. 2 shows how data streams are broadcast via an appropriate broadcast infrastructure 110 using the DVB (Digital Video Broadcasting) family of public satellite (DVB-S), and/or cable (DVB-C) and/or terrestrial (DVB-T) broadcast formats to television receiving apparatus 109 where composure of an SMS text message is employed to communicate information back to operator 100. The apparatus may comprise a set-top-box (STB) or personal video recorder (PVR) 114 that receives television services, including the data streams from the service operator 100, via an aerial, satellite dish or cable socket 116 and connects to a television 112 for display purposes via a screen 113 to one or a plurality of television users 118. Users 118 communicate with the operator 100 by composing SMS text messages and sending them to destination numbers allocated to the operator according to on-screen instructions displayed on screen 113.

Apparatus 109 may have several embodiments whereby the functionalities of the STB or the PVR 114 may be integrated, or partially integrated, with the television 112 and/or display screen 113. In another embodiment the functionality of the STB or the PVR 114 is performed by a personal computer (PC) and the television's display screen 113 function is performed by a display monitor. In another embodiment, the aerial 116, STB 114, television 112, remote control 117 and screen 113 functionalities are integrated into a single handheld device such as a cordless or mobile phone, PC notebook, media player or video jukebox, palmtop computer or a personal digital assistant (PDA).

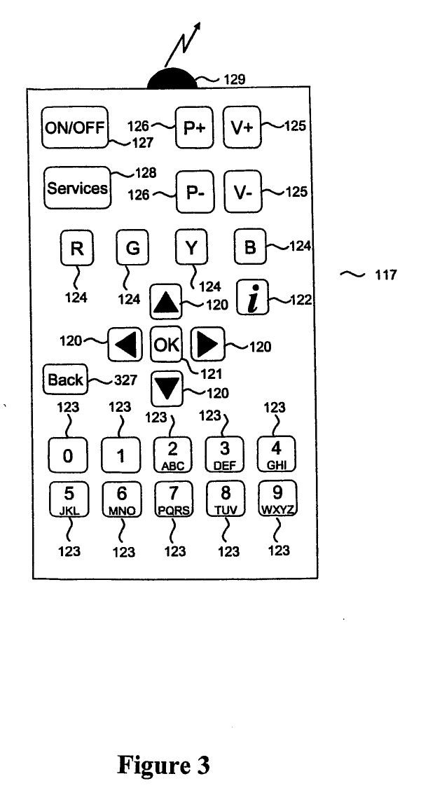

FIG. 3 shows a remote control 117 for controlling the apparatus 109. The remote control 117 sends commands to apparatus 109 preferably by wireless means. The remote control 117 uses an infrared transmitter 129 to send commands to apparatus 109 that correspond to keys as they are pressed by the user, where such keys include: apparatus power ON/OFF toggle 127, volume up/down 125, channel up/down 126, red/green/yellow/blue fastext keys 124, up/down/left/right cursor keys 120, OK/select key 121, 0-9 numeric keys 123 labelled with multiple tap alphabetic characters, a “Back” key 327 for reversing out of a user interface selection and a “Service” key 128 for causing the apparatus's service guide options to be displayed. Alternative embodiments for remote control 117 may include any device where keys are appropriately labelled to correspond to that of a television control device, such as may be achieved using a mobile or cordless telephone, a standard “QWERTY” keyboard, a personal digital assistant (PDA), or a touch sensitive, handheld display where portions of the display are marked with labels corresponding to television control commands.

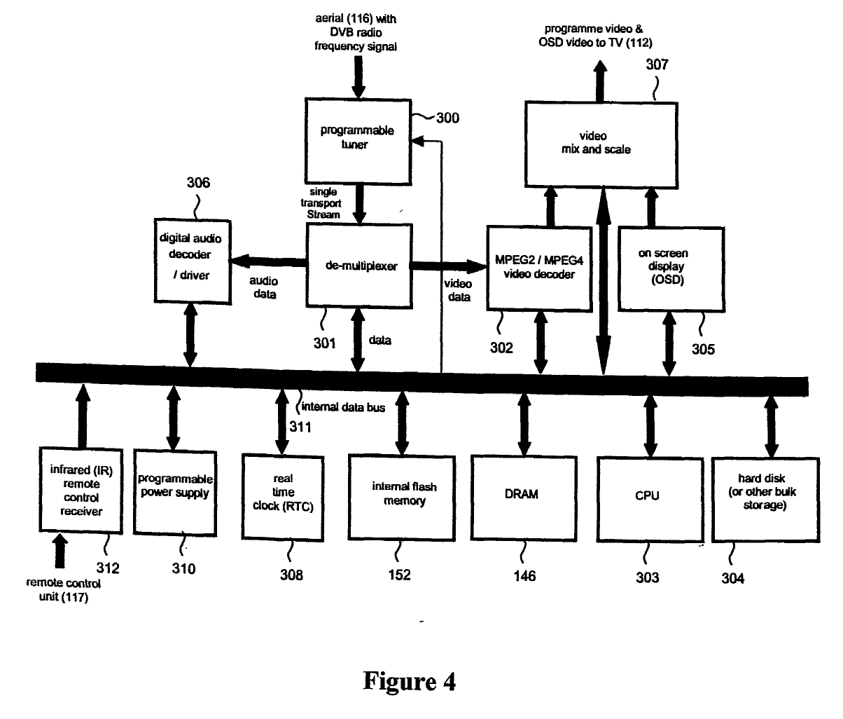

FIG. 4 shows the internal functional elements of a typical STB 114 designed to receive and decode DVB television transmissions. This has a CPU 303 coupled to volatile DRAM 146 and an internal, non-volatile (flash) memory 152 that are integral to and not removable from the apparatus. Communication between the CPU and the other blocks is via one or more internal data buses 311. The CPU receives user commands from remote control 117 via an infrared receiver 312. When the STB is in standby, a real time clock (RTC) or countdown timer 308 controls when portions of the STB are to be powered up. In the preferred embodiment, when the STB is in standby mode between downloads, the CPU and memory operate in a low power mode with all other blocks powered off completely, except an RTC 308, IR receiver 312 and programmable power supply 310. The power supply is controlled by the CPU to apply and remove power to or from one or more of the other blocks depending on whether the STB is required to enter an active, standby or download state. The STB may have personal video recording (PVR) features and contain some form of bulk storage device 304 connected via an ATAPI or SCSI hard disk interface.

The STB contains a programmable tuner 300, which is connected to receive DVB-T broadcasts via an aerial 116. Additionally or alternatively, the tuner may receive cable and satellite transmissions. Program tuner 300 and de-multiplexer 301 receive and decode MPEG2 transport streams (channel) present at aerial 116, including the streams (channels) carrying operator's 100 transmissions. The tuned transport stream is applied to a de-multiplexer 301, where elementary audio, video and data streams may be extracted. Video data streams are applied to the MPEG-2 and/or MPEG-4 video decoder 302. The output of this decoder is then combined with the on screen display OSD 305 to provide the video signal to the television 112. The OSD is responsible for displaying all graphical outputs to screen 113 of the applications. The video mix and scale function are capable of scaling the decoder video in order to present a reduced size live video display anywhere on television screen 113.

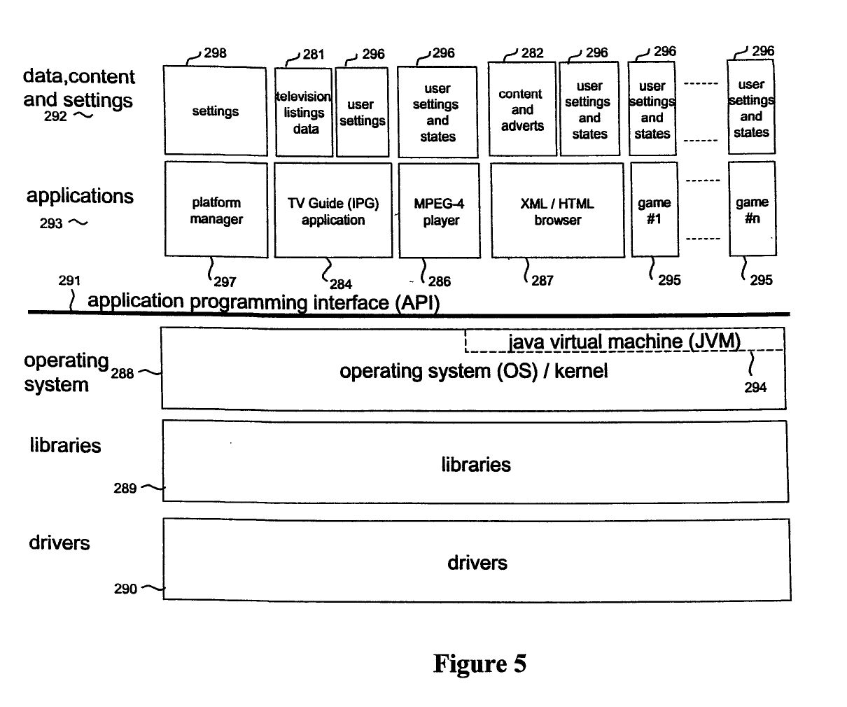

FIG. 5 shows the structure of programme application software, data, service content and settings stored for the preferred embodiment of apparatus 109. A platform manager application 297 controls the downloading of all other applications 293. In a preferred embodiment, operator data comprising data objects are loaded periodically by the platform manager over a broadcast infrastructure 110 into the volatile memory 146 that is arranged as a file system. Each object contains a numeric identifier. The platform manager 297 looks up within settings data 298 stored in the non-volatile memory 152 to determine which objects are to be downloaded. The settings data 298 includes a 32-bit apparatus address 299 that is unique for each apparatus and a one byte identifier 432 of the apparatus's manufacturer. Once the objects are downloaded, the platform manager authenticates and decodes them to construct a complete file system in volatile memory 146 of applications 293 and data content and settings 292 necessary for the apparatus's operation.

The other applications 293 include an IPG 284 which is launched by the user from a “TV Guide” option within a service guide user interface. Yet further applications include an extended mark-up language (XML) browser 287 employed to display marked up content 282 such as from the “TV magazine”, “News” and “Weather” service guide options and an audio video decoder 286 to playback television programmes, movies and clips. Additional applications include games 295 which are launched from a menu reached via a “Games” option on a service guide.

The applications 293 all communicate with an operating system 288 and code libraries 289, graphics and data communication drivers 290 and other components via a common application programming interface (API) 291. Each application 293 may have associated with it data, content and settings 292 which it may process. Preferably, all applications are adapted to run over Java, or some other form of virtual machine 294.

FIG. 6 shows the allocation of memory in the non-volatile memory 152. A word look up table 430 connects 1 to 3 character words to each of 256 possible byte values, for example:

| byte value | word value |
|---|---|
| 0x00 | “A” |
| 0x01 | “T” |
| 0x02 | “AT” |
| . . . | . . . |
| 0xFE | “OWL” |
| 0xFF | “TAP” |

Additionally, the apparatus maintains a table of one or more mobile telephones 431 registered within the non-volatile memory 152 for each user, for example:

| mobile telephone number (T) | coupling (C) | user |
|---|---|---|
| 0727 828142 | 1 | Dad |
| 0836 432295 | 0 | Lisa |

Here, each mobile number is associated with a coupling code and the name of the user. The invention allows a user to place an order for an interactive service via the apparatus without employing communications hardware that is integral or linked to the apparatus. The invention further provides for a process whereby the apparatus receives an entitlement from the operator and confirms activation of the service to the user via the screen. The order may be a request to play a game, or to play a part of a game or a set of games. Alternatively the order may be a request for a product or to subscribe to a service such as a games service, or to subscribe to a collection of different services such as a games service, a TV magazine service, a news service and a chat service.

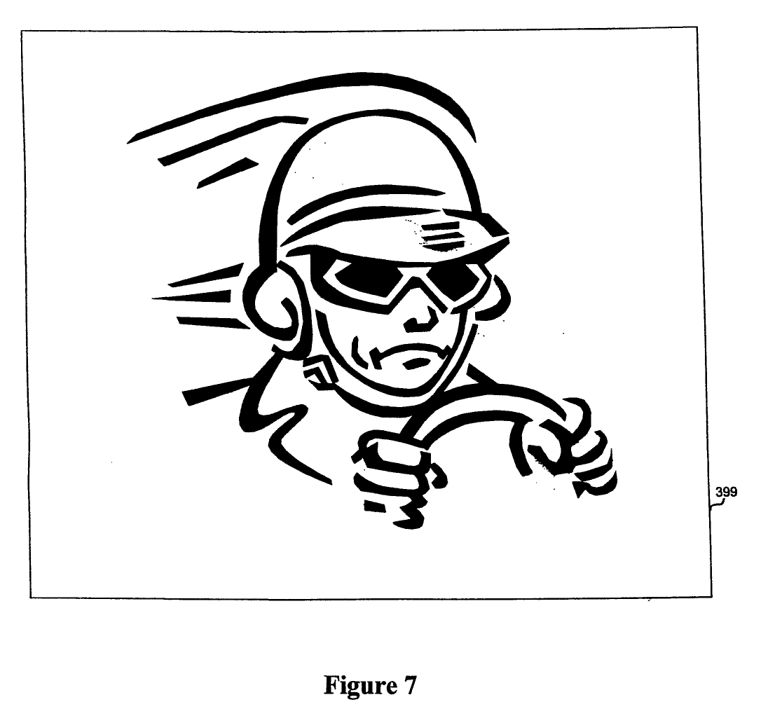

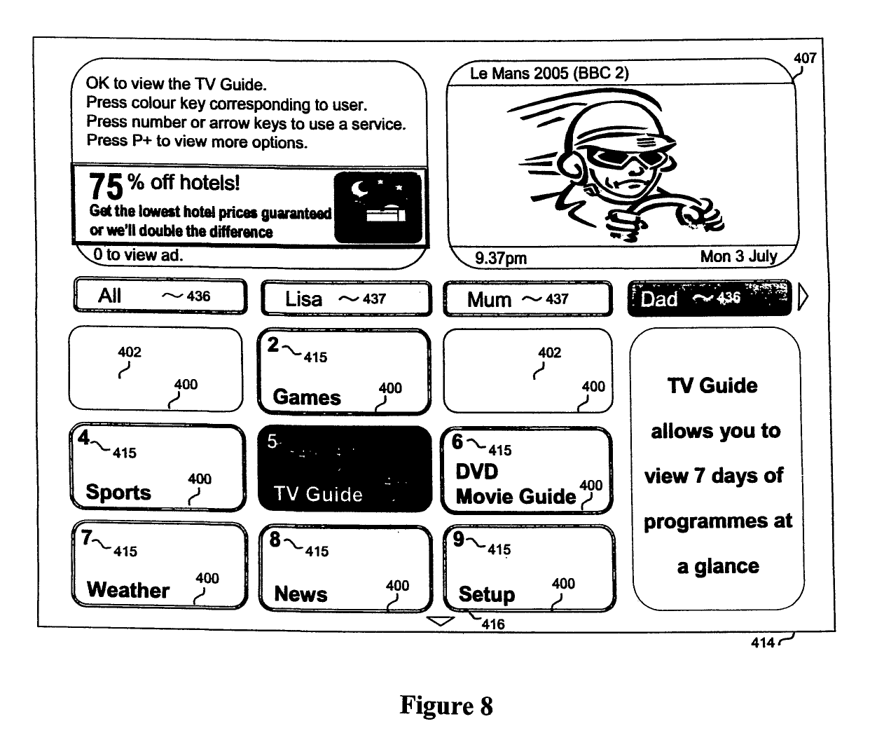

FIG. 7 shows the television receiving apparatus display when the user is watching full screen television 399. The user may cause the apparatus to display a service guide 414, as shown in FIG. 8, by pressing the Services key 128 on the remote handset 117. The service guide displays a 3 by 3 grid of cells 400. One of the cells 401, the so called “cell in focus”, is highlighted differently compared to the other cells to denote that the service it corresponds to will be selected when the user presses the OK key 121 on the remote handset. Each cell 400 corresponds to a different service and is labelled with the service's identity and a number 415. A user may move the focus, and hence move also the differential highlighting 401, to another cell 400 by pressing arrow key 120 corresponding to the desired direction. For example, pressing the left arrow 120 when the focus is on “TV Guide” moves the focus to “Sports”. Upon entry from full screen television 399, the central cell 401 is placed in focus. The service guide features a picture in graphic 407. This corresponds to the television channel previously displayed in full screen 399 when the service guide was invoked. Several persons 118 may share an apparatus in a typical home. The apparatus stores individual user preferences and settings for applications in non-volatile memory 152.

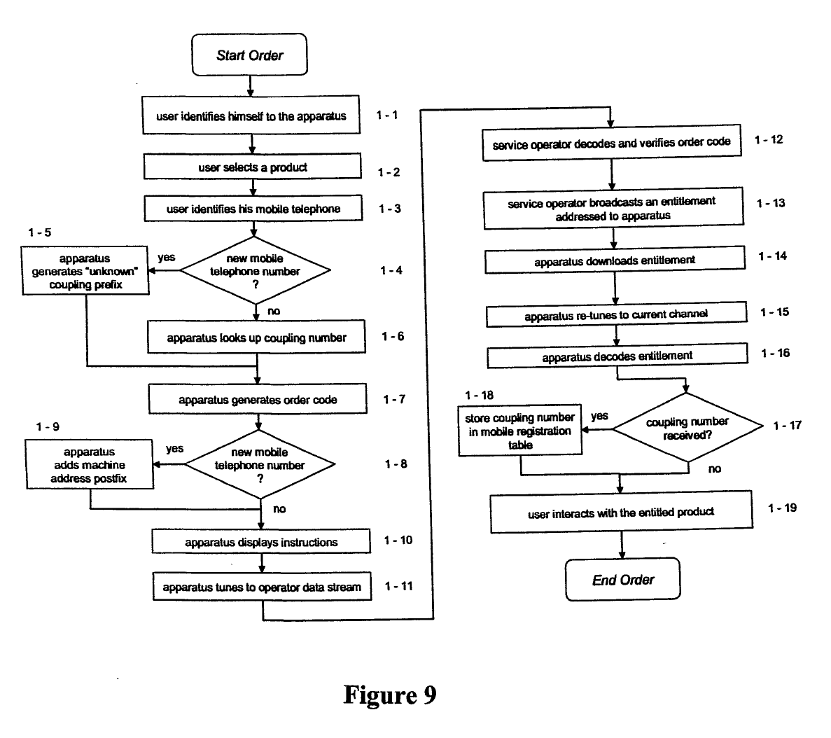

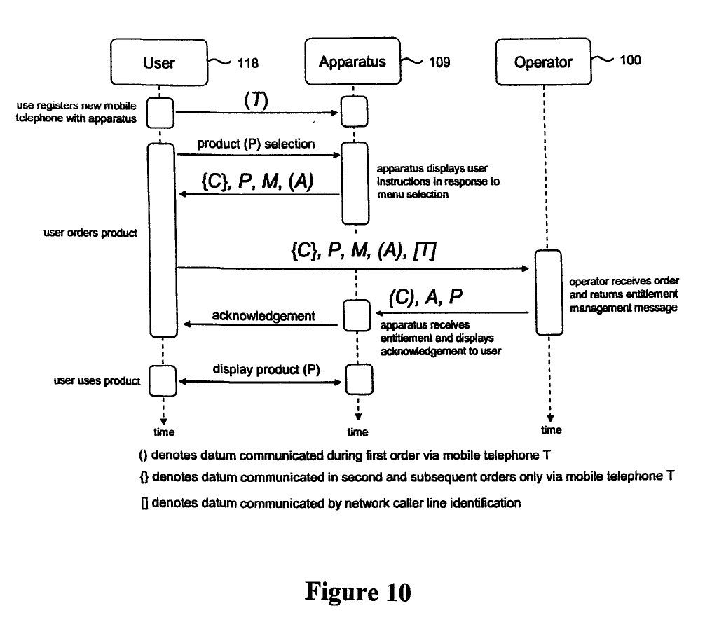

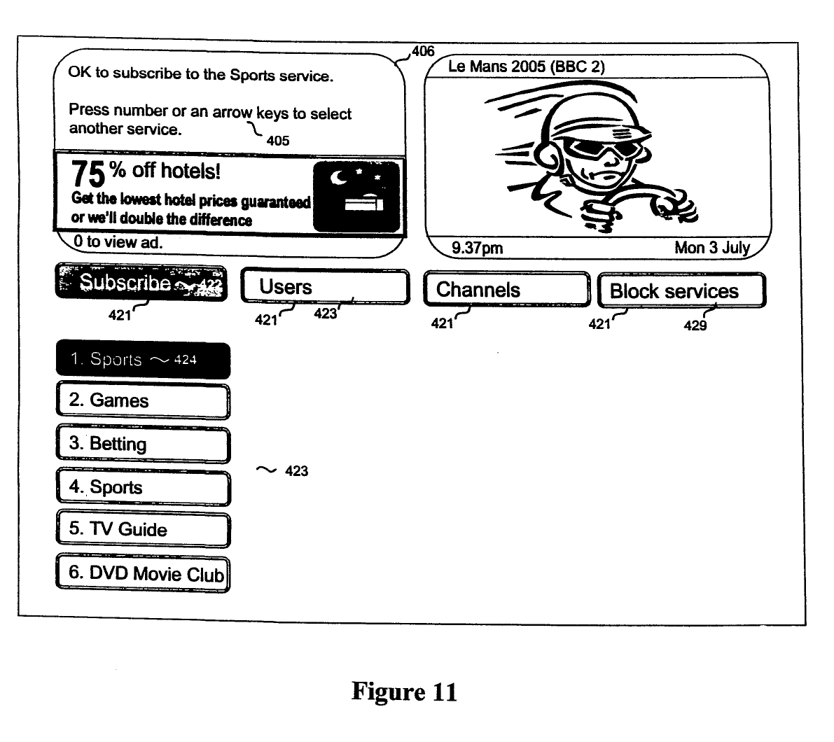

FIGS. 9 and 10 set out the steps that allow a user to use or order services according to personal preferences. This is done by the user firstly identifying himself to the apparatus [1-1] by selecting one 436 of a number of coloured cells 436 and 437, each bearing the name of a user of the apparatus. A user may subscribe to a particular service by entering a key (“9”) corresponding to the cell 400 corresponding to the “Setup” function, causing a menu of services 420 available for subscription to be displayed, as shown in FIG. 11. The set-up menu supports a number of user selectable setup functions, each denoted by a cell 421 whose colour corresponds to a fastext key of the same colour on the remote control 117. User instructions 405 that are responsive to the cell in focus are displayed in a panel 406 in order to assist users through the set up process. By default, the “subscribe” set up option cell 422 is already selected and a column of cells 423, each corresponding to a service subscription option is displayed.

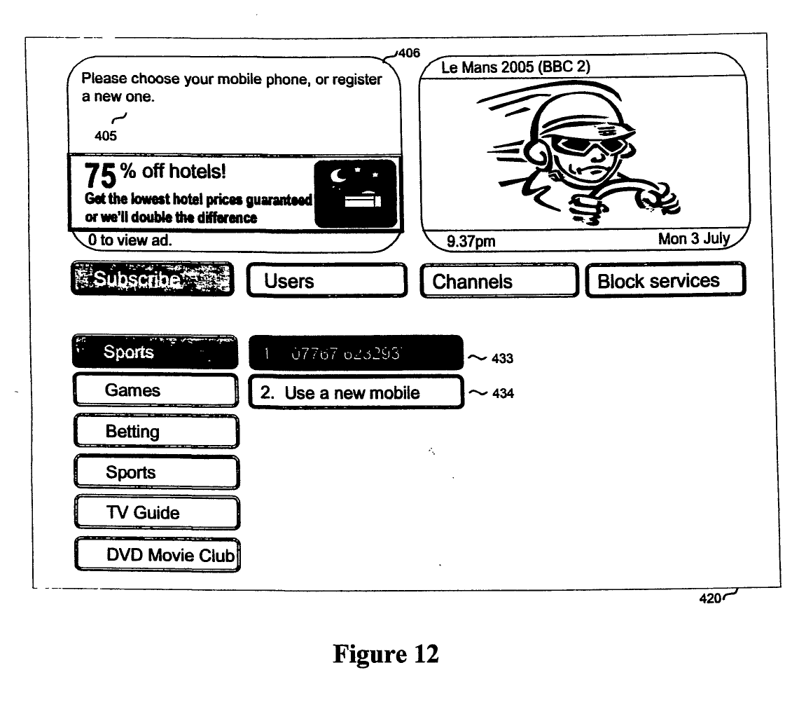

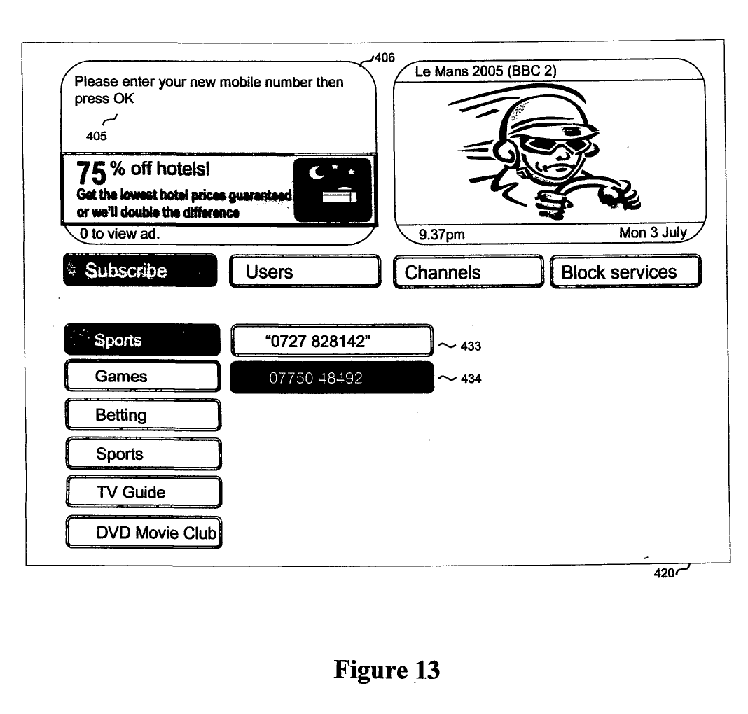

As shown in FIG. 11, one of the cells is in focus 424. A user may select a service product [1-2] for subscription from column 423 by pressing the number key 123 on the remote that corresponds to its number or by using the up or down arrow keys 120 to move the focus to the cell of interest and then press the OK key 121. Upon selecting a service, the apparatus displays one or more mobile telephone numbers 433 or, alternatively, names of owners of mobile telephones (not shown) and prompts the user to determine whether the order will be placed using an existing mobile telephone number 433 (or owner's name) or via a new one 434 [1-3]. In the latter case the apparatus prompts the user to key a new mobile telephone number into the prompt cell 434, as shown in FIG. 12. Once entered, cell 434 displays that new number, as shown in FIG. 13.

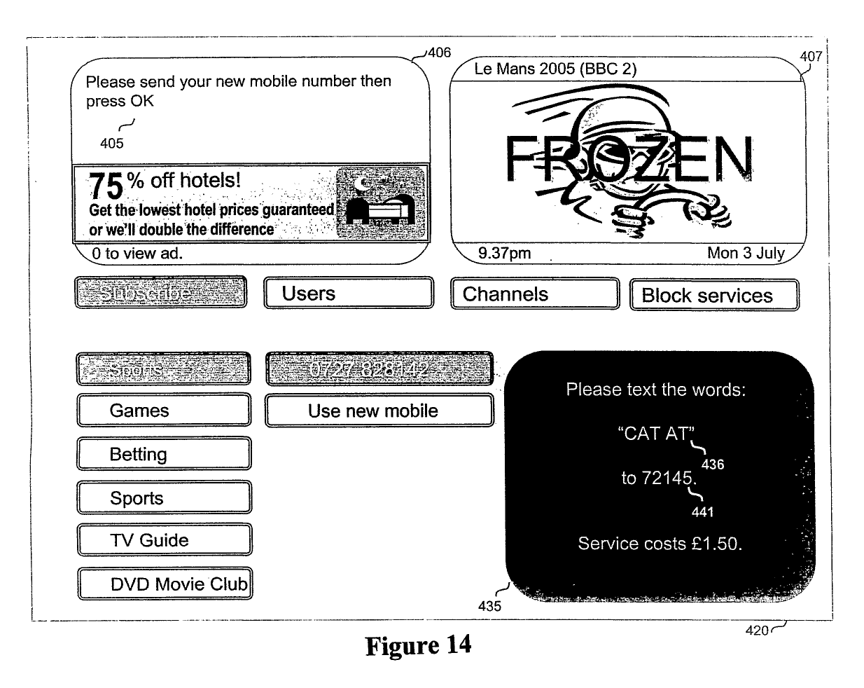

In order to return an entitlement message, it is necessary for the user to communicate the address of the apparatus to the operator. To do this, the apparatus looks up the mobile telephone number in its table of mobile telephones 431. If a previous mobile telephone number is used [1-4] then the apparatus concatenates its associated coupling number [1-6] with an order code containing the identity of the requested product or service [1-7]. In the embodiment described, one hexadecimal digit is allocated to the coupling number and one hexadecimal digit is allocated to the product identifier (i.e. a maximum of 16 different possible products can be specified). Consequently, the apparatus generates a one byte order code: 0xcp, where c andp are expressed as half byte nibbles respectively. For example, using the “0727 828142” mobile telephone number of FIG. 14 “Dad's” coupling number is 0x1 and assuming 0x3 is the product identifier for the “Sports” service, the order code would be 0x13.

If the mobile telephone number is new [1-4] because the user has entered a new mobile telephone number then the coupling number is replaced by a reserved code, 0xF, to signal that it is unknown [1-5] and further concatenated [1-9] with the manufacturer identifier, M, and the apparatus address, A, where the hexadecimal digits occupying the leading zero bytes in A are omitted: 0xcpmmaa[aaaaaa], where M and A are expressed as nibbles m and a respectively. As per the previous example, but assuming a new mobile telephone is being used to order the sports service and that 0x3A is the manufacturer's identifier and 0x0013FFA1 is the apparatus address, then the order code would be a 5 byte sequence: 0xF33A13FFA1. The apparatus next encodes the order code by replacing each byte in the order code sequence with its corresponding word found in the word lookup table to form a space delimited word sequence 436. For example, in the present case, the sequence would be “CAT AT” 436. The apparatus then displays instructions to the user to send the word sequence as an SMS text message to a destination number 441 [1-10]. The apparatus simultaneously freezes or blanks the picture in graphic video 407, mutes the sound and programmes the tuner 300 and de-multiplex stages to receive the operator broadcast data objects [1-11].

The SMS text message traverses the telephone network 108 and is received at the SMS gateway 138 where its constituent parts, the message text 400, the destination number 441 and the caller line identify of the user's mobile telephone 111 are forwarded in real time to the order decoder 134. Each word in the message text 436 is transposed with its corresponding byte value as looked up within the word look up table stored within the call decoder in order to restore the order code to a byte sequence [1-12]. If the coupling number, C, is received (i.e. the value of C is not 0xF) the call decoder next looks up within its mobile telephone table to locate the apparatus address that corresponds to the caller line identity and the coupling number. If on the other hand C is not received (i.e. C=0xF), the call decoder creates a new record in its telephone number table by filling the mobile telephone number field with the caller line identity, filling the manufacturer identifier field with mm contained within the order code and filling the apparatus address field with AAAAAAAA contained within the order code.

Next the call decoder looks through the mobile telephone table to determine a new coupling number C that is unique across all records containing the same mobile telephone number, preferably by incrementing the highest coupling number previously stored. If no records matching the caller identity are found, a coupling number of 0 is used. Assuming the caller identity is per the new mobile telephone 434 entered in FIG. 13 and that it has not previously been registered with the operator, the new record added to the call decoder's mobile table would be:

| Mobile | manufacturer | | |
|---|---|---|---|
| telephone | identifier | | coupling |
| number (T) | (M) | apparatus address (A) | (C) |
| 07750 48492 | 0x3A | 0x001BFFA1 | 0 |

The call decoder next confirms that the product code, p, is valid and, if so, the operator 100 broadcasts a message using the apparatus address, AAAAAAAA, causing the apparatus to entitle the product p [1-13]. If the coupling number was not contained in the order code (because it was unknown) then the coupling number, C, is also included in the message.

The entitlement message is broadcast via the data services broadcaster 101 and multiplex broadcaster 106. The message is filtered and downloaded by the apparatus with the unique AAAAAAAA address [1-14], whereupon the apparatus displays an acknowledgement to the screen, restores tuning to the current channel [1-15], decodes the entitlement in order to enable the product, P [1-16]. If a coupling number C is included in the message [1-17], the apparatus creates and stores a new record in the mobile telephone registration table 431 using the mobile telephone number and the coupling number supplied by the operator [1-18]. Finally, the user uses the service product [1-19] such as, for example, by selecting the “Sports” cell in FIG. 8.

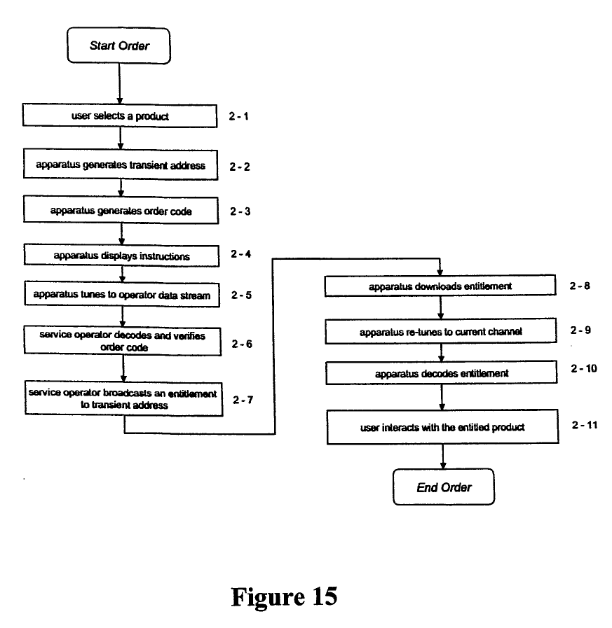

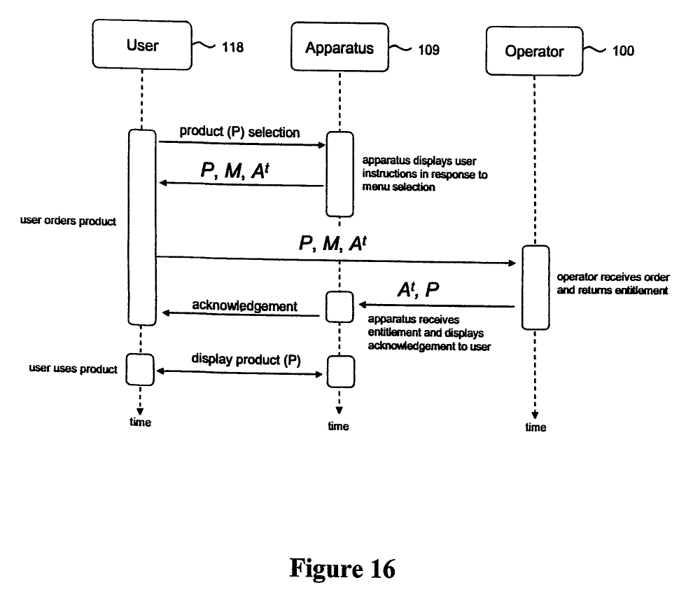

FIG. 15 shows a method in which the step of identifying a user's mobile telephone to the apparatus [1-3] is omitted and where communication to the operator of the full apparatus address, A, is replaced by a shorter “transient” address A^{t} which is created by the television receiving apparatus and discarded after the order process. The transient address is not unique, so that same address values and may be created by different television receivers for different orders at later times. This method has the benefit that the user order code is shorter for the first order than compared to the previous method. A summary of the data exchange in this case is shown in FIG. 16.

As before, the user selects a product [2-1] via an on screen menu. The apparatus then generates a pseudo-random number for the address A^{t} [2-2]. A^{t} is significantly shorter than the apparatus address and is typically 12 bits (3 nibbles). As previously, the apparatus constructs an order code, in this case by concatenating together the product identifier, the manufacturer identifier and the apparatus transient address [2-3]: 0xpmma^{t}a^{t}a^{t}, where A^{t} is expressed in nibbles as a^{t}. The apparatus next encodes the order code into a sequence of words using the same process of substituting bytes in the order code for corresponding bytes in the word table 430 separated by spaces as delimiters [2-4] and displays the order code using a similar visual style as previously shown 435 in FIG. 14. As before, the user then sends the order code to the SMS gateway 138. The apparatus tunes to the operator data stream and filters for messages addressed to the transient address [2-5]. The service operator decodes the order code by substituting bytes for words from its local copy of the word table and verifies that the product code p is valid [2-6], broadcasts an entitlement back to the apparatus addressed to the transient address [2-7]. The apparatus then downloads the entitlement [2-8], re-tunes to the current channel [2-9] and decodes the entitlement [2-10] to enable use of the product [2-11].

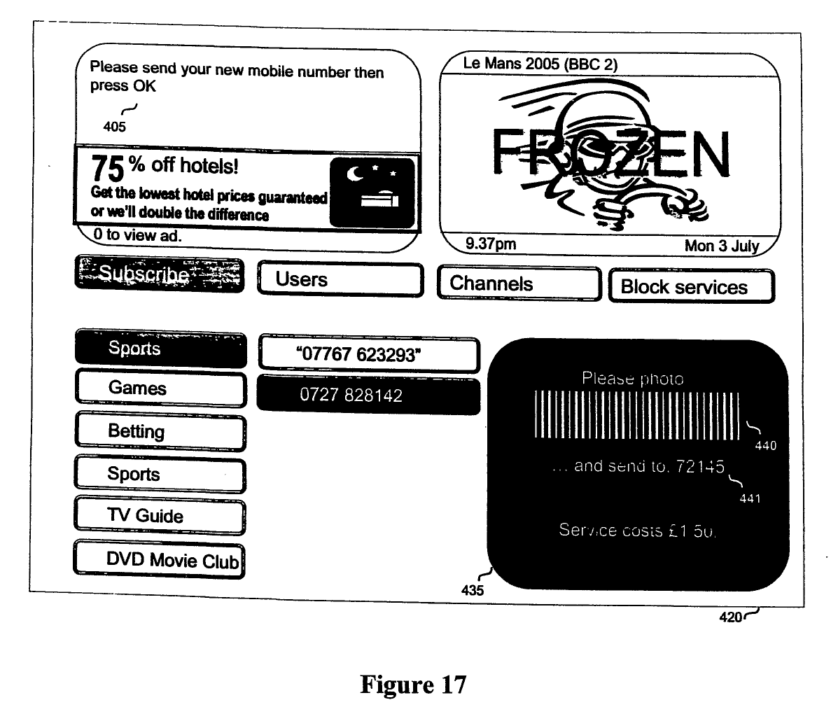

A skilled person will appreciate that variations of the disclosed arrangements are possible. For example, many of the functional elements described in FIG. 4 may be combined on a single large-scale integration (LSI) silicon component such as STMicroelectronics' STi5100 chipset and may be included in a set top box that is external to the television. Alternatively, in the case of a digital television receiver all the functions of FIG. 4 may be resident within the television chassis. Also, the order code may be encoded and displayed as an image, such as a bar code 440 as shown in FIG. 17 which is photographed by a mobile telephone with integral camera wherein the image is decoded to reveal the order code text by a Java application previously downloaded to the mobile telephone. Alternatively, the whole image may be transmitted by the mobile telephone for call decoding by the call decoder. In another example, the mobile telephone number may be expressed as an internet address on voice over internet (VoIP) telephony networks. Further, the operator and the apparatus may be connected across a bi-directional network such as the internet, where the apparatus address may also be an internet address. Accordingly the above description of the specific embodiment is made by way of example only and not for the purposes of limitation. It will be clear to the skilled person that minor modifications may be made without significant changes to the operation described.

1. A method for providing services to a television system, the method comprising receiving a user message via a telephone line, the message including a translated version of user information; using the message received to identify an address for the television system associated with the user and broadcasting a return message for receipt by the television system, the return message including the television system address.

2. A method as claimed in claim 1 wherein the user message includes a television service request.

3. A method as claimed in claim 1 wherein the user message includes a translated version of the television system address.

4. A method as claimed in claim 3 wherein the television address is a transient address.

5. A method as claimed in claim 4 wherein the address is a one-time use address.

6. A method as claimed in claim 4 wherein the address is generated by the television system using a pseudo-random generator.

7. A method as claimed in claim 1 wherein the user message includes a service request and the return message includes an entitlement message, which entitles a user to access that service.

8. A method as claimed in claim 1 wherein the translated information comprises one or more short character strings.

9. A method as claimed in claim 1 wherein the user message is a text message.

10. A method as claimed in claim 1 comprising storing user telephone numbers and identifying a user from the telephone number from which the user message is received.

11. A method as claimed in claim 10 comprising storing in association with the user's telephone number a television system address for the user's television system.

12. A method as claimed in claim 11 comprising storing in association with the user's telephone number addresses for a plurality of television systems, each television address being allocated a coupling code.

13. A system for providing television services, the system comprising means for receiving a user message via a telephone line, the message including a translated version of user information; means for using the message received to identify an address for the television system associated with the user and means for broadcasting a return message for receipt by the television system, the return message including the television system address.

14. A method for accessing television services, the method comprising sending to a service provider a user message via a telephone line, the message including a translated version of user information and enabling identification of an address for a television system associated with the user and receiving a return message at the television system via a television broadcast channel.

15. A method as claimed in claim 14 comprising receiving one or more user selections and providing a translated version of user information in response to the user selections for transmission to the service provider.

16. A method as claimed in claim 14 comprising identifying at the television system one of a plurality of registered users and including in the user information a code associated with that user.

17. A method for accessing interactive television services comprising generating at a television apparatus a transient address; storing that address; sending the address to a service provider; and receiving service information via a television broadcast signal.

18. A method as claimed in claim 17 wherein the generated address is a one-time use address.
